(19) United States
(12) Patent Application Publication
(10) Pub. No.: US 2012/0154087 A1
(43) Pub. Date: Jun. 21, 2012

(54) Signal Isolation Transformer

(76) Inventor: Frank Chen, Taipei County (TW)

(21) Appl. No.: 12/972,390

(22) Filed: Dec. 17, 2010

(51) Int. Cl. H01F 27/04

(52) U.S. Cl. 336/90

(57) ABSTRACT

An isolation transformer including a magnetic element, a plurality of conductive elements and an insulative casing is disclosed. The magnetic element is accommodated in the insulative casing. The conductive elements are fastened in a pair of walls of the insulative casing. Each of the conductive elements has a plate, one end of which is divided into a first contact portion and a second contact portion. The second contact portion is further bent and in association with the first contact portion to form a slot for being passed through by a wire of the magnetic element. Thus the wire can be clipped by the two contact portions.

### BACKGROUND OF THE INVENTION

1. Technical Field

The invention relates to transformers, particularly to isolation transformers for network.

2. Related Art

A signal isolation transformer is a magnetic component between an interface of a terminal device and an Ethernet transceiver. These transformers have two kinds. The first kind is to be installed in RJ45 connectors, the second kind is to be soldered on circuit boards.

A typical transformer with ceramic package for being mounted on a circuit board is illustrated in FIG. 1. A magnetic element 10 is accommodated in an insulative casing 11. Wires of the magnetic element 10 must be connected with pins 12 of the insulative casing 11.

In such a transformer, the connections between the wires 13 and the pins 12 must be implemented within the insulative casing 11. Thus those connections have to occupy the inner space of the insulative casing 11. Further, those connections are made by soldering. The wires 13 must be wound around the pins 12 before soldering. This winding process is performed only by manual operation. It is uneconomical for manufacture.

### SUMMARY OF THE INVENTION

An object of the invention is to provide a signal isolation transformer, which can simplify the manufacturing process and increase production efficiency.

Another object of the invention is to provide a signal isolation transformer, which can improve the volumetric efficiency to accommodate more transformer units in a specific casing.

To accomplish the above objects, the isolation transformer of the invention includes a magnetic element, a plurality of conductive elements and an insulative casing. The magnetic element is accommodated in the insulative casing. The conductive elements are fastened in a pair of walls of the insulative casing. Each of the conductive elements has a plate, one end of which is divided into a first contact portion and a second contact portion. The second contact portion is further bent and in association with the first contact portion to form a slot for being passed through by a wire of the magnetic element. Thus the wire can be clipped by the two contact portions.

### BRIEF DESCRIPTION OF THE DRAWINGS

FIG. 1 is a schematic view of a conventional signal isolation transformer;

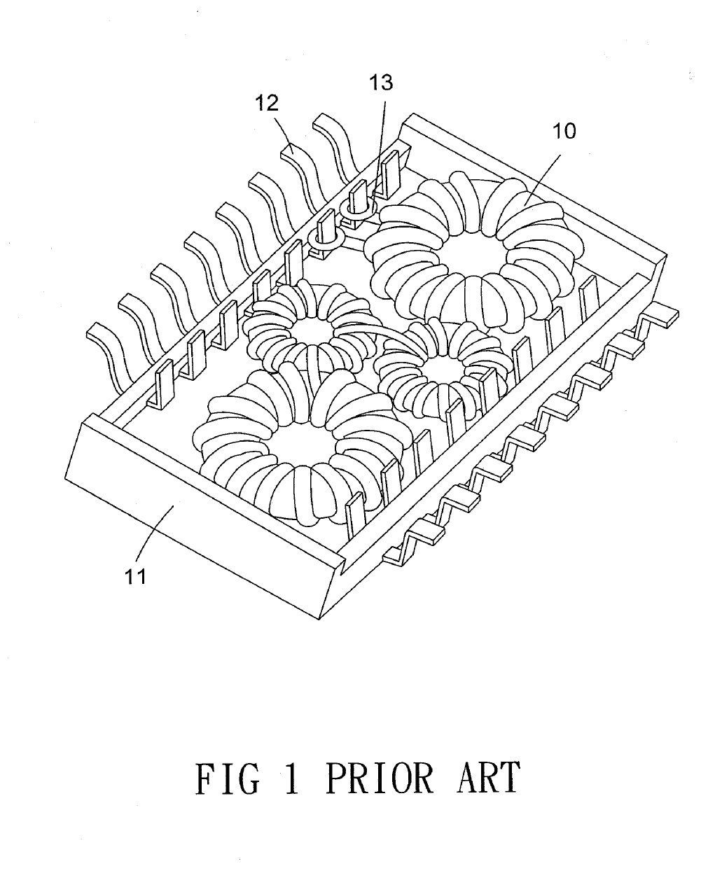

FIG. 2 is an exploded view of the invention;

FIG. 3 is an exploded view of the invention in another view angle;

FIG. 4 is a perspective view of the conductive element;

FIG. 5 is an assembled view of the invention;

FIG. 6 is a partially cross-sectional view of the invention; and

FIG. 7 shows another embodiment of the invention.

### DETAILED DESCRIPTION OF THE INVENTION

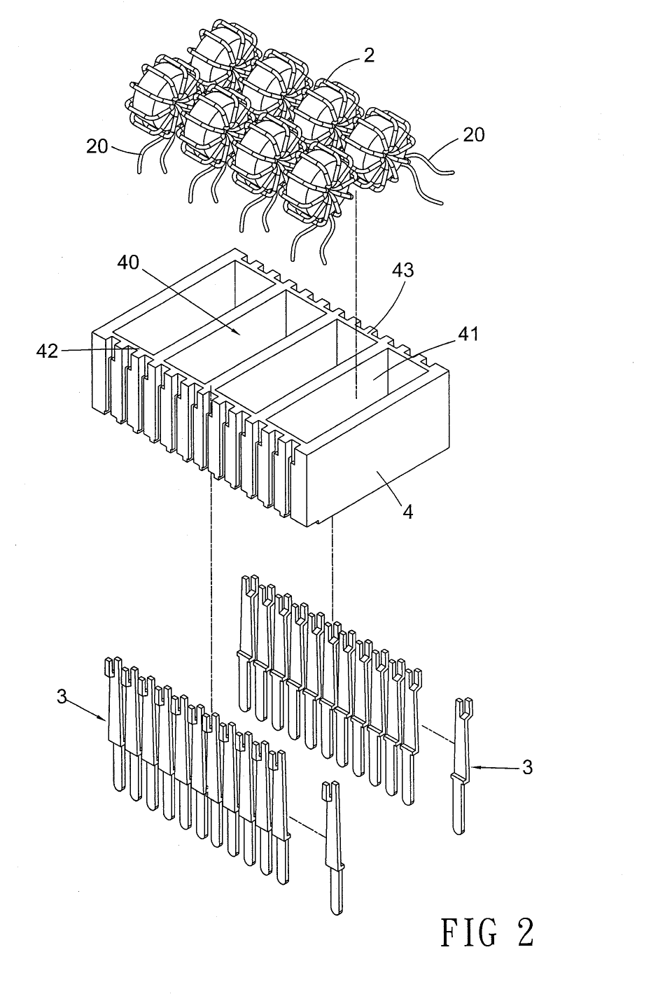

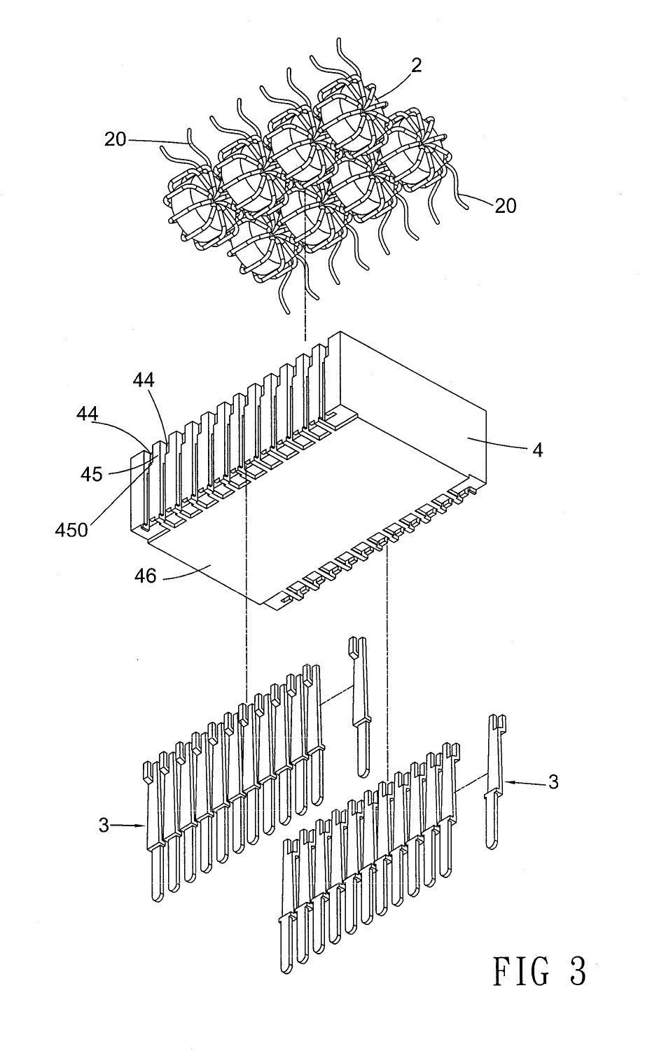

Please refer to FIGS. 2 and 3. The isolation transformer of the invention includes a magnetic element 2, a plurality of conductive elements 3 and an insulative casing 4.

The insulative casing 4 is provided with an opening 40, at least one space 41 communicating therewith for accommodating the magnetic element 2 and a pair of walls 42, 43 for fastening the conductive elements 3.

The magnetic element 2 has wires 20 connecting with the conductive elements 3. The wires 20 are enameled.

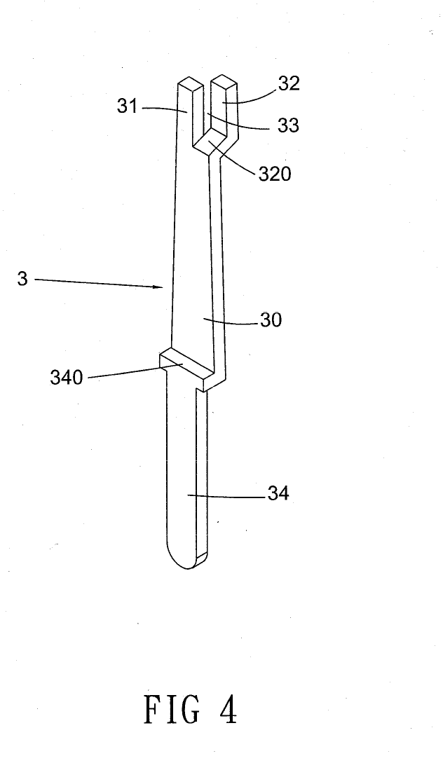

Please refer to FIG. 4. Each of the conductive elements 3 has a plate 30 fastened in the insulative casing 4. One end of the plate 30 is divided into a first contact portion 31 and a second contact portion 32. The second contact portion 32 is further bent outwards so as to form a slot 33 which can be passed through by the wire 20. The other end of the plate 30 is formed with a pin 34.

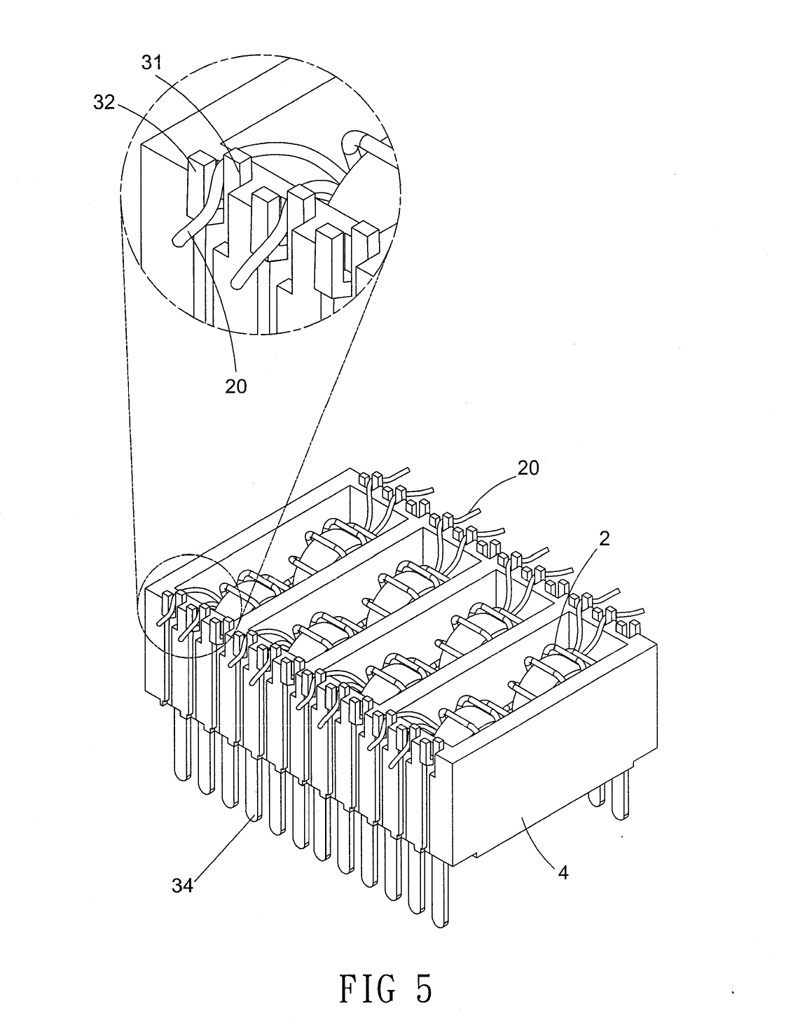

Please refer to FIG. 5. The magnetic element 2 is put in the insulative casing 4 through the opening 40. The wires 40 protrude from the opening 40 and then are squeezed into the slot 33 to be clipped by the first and second contact portions 31, 32. Particularly, the insulative enamel coated on the wires 20 is rubbed off to make an electric connection with the conductive elements 3 while the wires 20 are being squeezed into the slot 33.

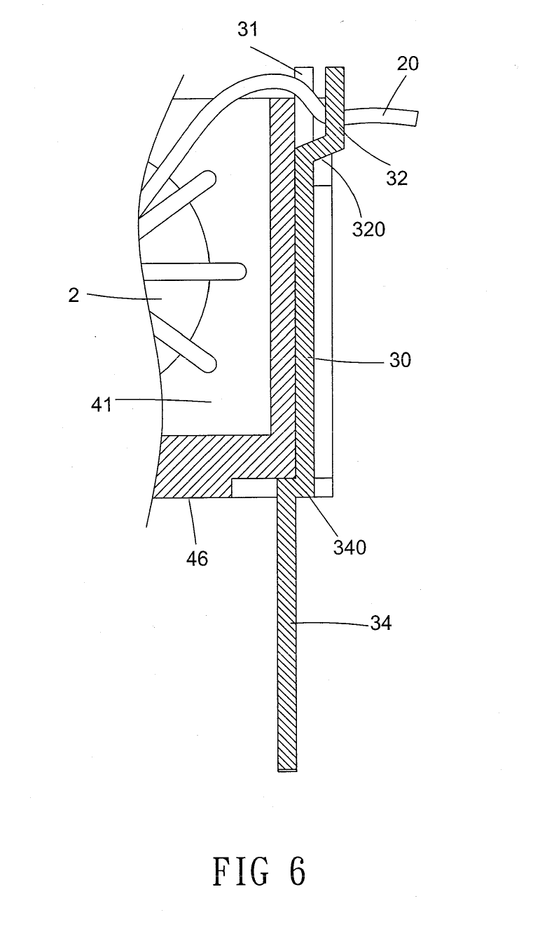

Please refer to FIGS. 2, 3 and 6. In order to fasten the conductive elements 3, the walls 42, 43 are formed with a plurality of parallel troughs 44 for separately inserting the conductive elements 3. A separator rib 45 is formed between every two adjacent troughs 44, and a blocker 450 is disposed on each the separator rib 45 to prevent the conductive elements 3 from escaping outwards. The conductive elements 3 can be fastened in the troughs 44 because the plates 30 taper off towards the contact portions 31, 32.

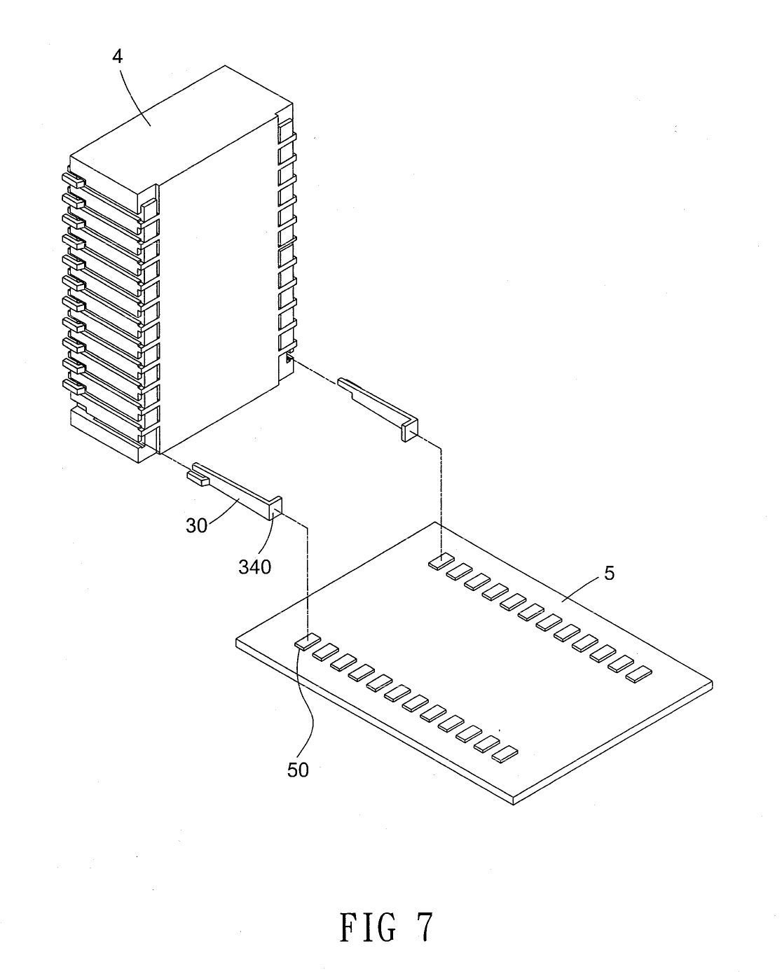

Preferably, each the pin 34 is formed with a bend 340 connecting the plate 30, which can further prevent the contact elements 3 from escaping. Another embodiment of the bend 340 is shown in FIG. 7. The bends 340 may be used to connect with connecting points 50 on a circuit board 5.

It will be appreciated by persons skilled in the art that the above embodiments have been described by way of example only and not in any limitative sense, and that various alterations and modifications are possible without departure from the scope of the invention as defined by the appended claims. It will be appreciated by persons skilled in the art that the above embodiment has been described by way of example only and not in any limitative sense, and that various alterations and modifications are possible without departure from the scope of the invention as defined by the appended claims.

What is claimed is:

1. An isolation transformer comprising:
an insulative casing having an opening, a pair of walls and a space communicating with the opening;
a magnetic element, having wires and accommodated in the space of the insulative casing; and
a plurality of conductive elements, connecting with the wires, fastened in the pair of walls, wherein each of the conductive elements has a plate, one end of the plate is divided into a first contact portion and a second contact portion, the other end of the plate is extended with a pin, and the second contact portion is further bent and in association with the first contact portion to form a slot for being passed through by one of the wires.

2. The isolation transformer of claim 1, wherein the walls are formed with a plurality of parallel troughs for separately inserting the conductive elements, a separator rib is formed between every two adjacent troughs, and a blocker is disposed on each the separator rib to prevent the conductive elements from escaping outwards.

3. The isolation transformer of claim 2, wherein the plates taper off towards the first and second contact portions so that the conductive elements are fastened in the troughs.

4. The isolation transformer of claim 1, further comprising a bend formed between the pin and the plate.
